(19) United States
(12) Patent Application Publication
(10) Pub. No.: US 2014/0173309 A1
(43) Pub. Date: Jun. 19, 2014

(54) INFORMATION PROCESSING APPARATUS, AND CONTROL METHOD FOR INFORMATION PROCESSING APPARATUS

(71) Applicant: KABUSHIKI KAISHA TOSHIBA, Tokyo (JP)

(72) Inventor: Takashi Iwai, Hamura-shi (JP)

(21) Appl. No.: 13/936,604

(22) Filed: Jul. 8, 2013

(30) Foreign Application Priority Data
Dec. 18, 2012 (JP) 2012-276145

(51) Int. Cl. G06F 1/32

(52) U.S. Cl. CPC G06F 1/3234
USPC 713/320

(57) ABSTRACT

One embodiment provides an information processing apparatus including: a main body; a CPU provided in the main body, a limit value being set for an instantaneous power consumption of the CPU; a measuring module configured to measure a power that is being supplied to the main body; and a setting module. The setting module sets the limit value into a first value so that the power does not exceed a first instantaneous value, and if an accumulation time during which the power exceeds a second instantaneous value that is smaller than the first instantaneous value has reached a first threshold time within a prescribed time period, further sets the limit value into a second value so that the power does not exceed the second instantaneous value.

### CROSS-REFERENCE TO RELATED APPLICATION(S)

This application claims priority (priorities) from Japanese Patent Application No. 2012-276145 filed on Dec. 18, 2012, the entire contents of which are incorporated herein by reference.

### FIELD

Embodiments described herein relate generally to an information processing apparatus and a control method for an information processing apparatus.

### BACKGROUND

Electronic apparatus, information processing apparatus, etc. are continuing to be required to perform a more appropriate power consumption control.

There seems to be no technique for performing a more appropriate power consumption control without varying the standard frequency itself.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 is a perspective view of a personal computer according to an embodiment.

FIG. 2 shows the system configuration of the personal computer according to the embodiment.

FIG. 3 is a block diagram of a CPU used in the embodiment.

FIG. 4 is a functional block diagram of the personal computer according to the embodiment.

FIG. 5 is a flowchart of a power consumption control according to the embodiment.

FIG. 6 is a graph showing a system power variation in the embodiment.

### DETAILED DESCRIPTION

One embodiment provides an information processing apparatus including: a main body; a CPU provided in the main body, a limit value being set for an instantaneous power consumption of the CPU; a measuring module configured to measure a power that is being supplied to the main body; and a setting module. The setting module sets the limit value into a first value so that the power does not exceed a first instantaneous value, and if an accumulation time during which the power exceeds a second instantaneous value that is smaller than the first instantaneous value has reached a first threshold time within a prescribed time period, further sets the limit value into a second value so that the power does not exceed the second instantaneous value.

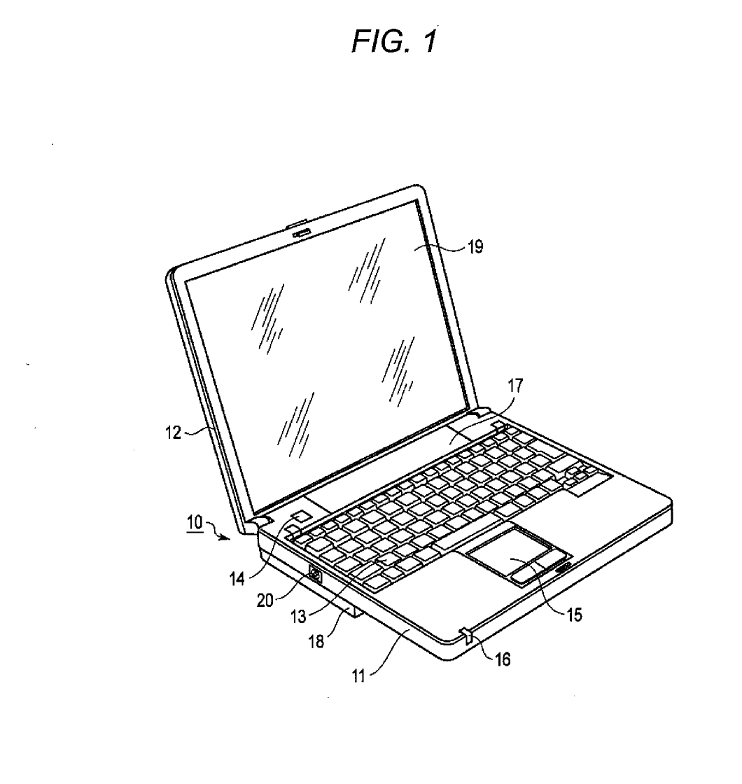

Embodiments will be hereinafter described with reference to FIGS. 1-6.

The configuration of an information processing apparatus according to the embodiment will be described with reference to FIG. 1. This information processing apparatus is a portable personal computer 10 which can be driven by a battery. FIG. 1 is a perspective view, as viewed obliquely from the front side, of the portable personal computer 10 with its display unit 12 opened.

The personal computer 10 is composed of a computer main body 11 and a display unit 12. The display unit 12 incorporates a display device which is an LCD (liquid crystal display) 19.

The display unit 12 is supported by the computer main body 11, and attached to the computer main body 11 so as to be rotatable between an open position where it exposes the top surface of the computer main body 11 and a closed position where it covers the top surface of the computer main body 11. The computer main body 11 has a thin, box-shaped cabinet, and a keyboard 13, a power switch 14 for powering on/off the personal computer 10, and a touch pad 15 are arranged on the top surface of the computer main body 11.

A side surface (e.g., the left side surface) of the computer main body 11 is provided with a power connector 20. An external power device is detachably connected to the power connector 20. The external power device can be an AC adapter which is a power device for converting commercial power (AC power) into DC power.

The power connector 20 is a jack to which a power plug which is provided at one end of a line leading from the external power device such as an AC adapter can be detachably connected. A battery 17 is detachably provided in a rear end portion of the computer main body 11.

The personal computer 10 is driven by power that is supplied from the external power device or the battery 17. If the external power device is connected to the power connector 20 of the personal computer 10, the personal computer 10 is driven by power that is supplied from the external power device. Power that is supplied from the external power device is also used for charging the battery 17. The battery 17 may be charged not only while the personal computer 10 is powered on but also while it is powered off. While the external power device is not connected to the power connector 20 of the personal computer 10, the personal computer 10 is driven by power that is supplied from the battery 17.

The computer main body 11 is provided, on the front side, for example, with an indicator 16 for notification of various power statuses such as connection/non-connection of the external power device. The indicator 16 may be an LED. A spacer 18 serves to keep a rear portion of the computer main body 11 high.

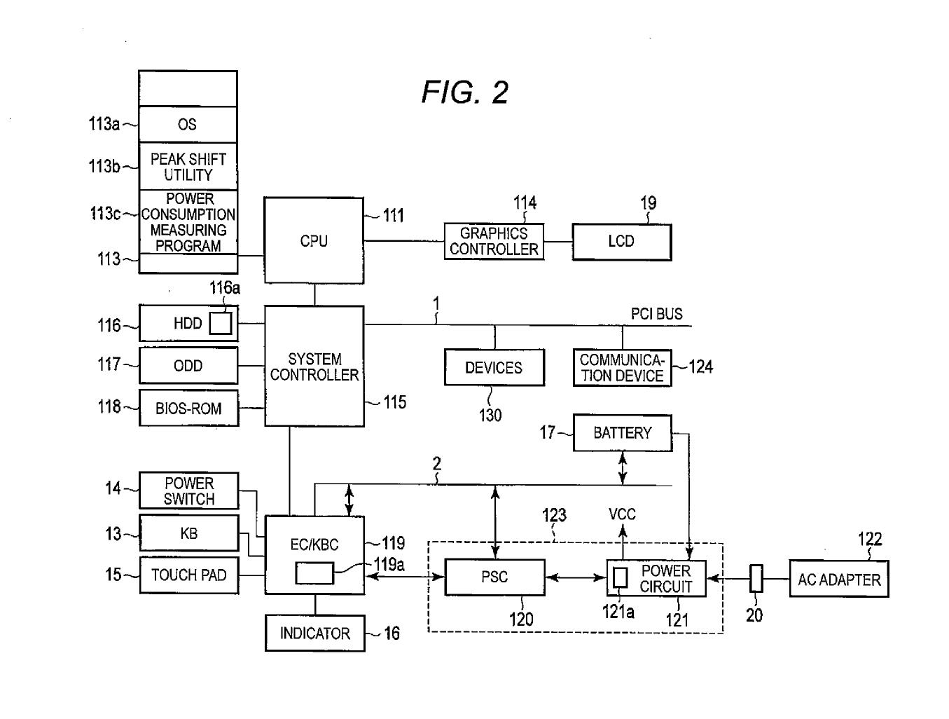

FIG. 2 shows the system configuration of the personal computer 10. The personal computer 10 is equipped with a main memory 113, a graphics controller 114, a system controller 115, a hard disk drive (HDD) 116, an optical disc drive (ODD) 117, a BIOS-ROM 118, an embedded controller/keyboard controller (EC/KBC) 119, a power controller (PSC) 120, a power circuit 121, an AC adapter 122, etc. The AC adapter 122 is used as the above-described external power device. In the embodiment, the power controller 120 and the power circuit 121 function as a power consumption measuring circuit 123 for measuring power that is supplied from the external power device (AC adapter 122). The power consumption measuring circuit 123 measures a power value not only while the personal computer 10 is powered on but also while it is powered off. In the embodiment, power that is supplied from the external power device is considered a power consumption of the personal computer 10. The EC/KBC 119 which functions as a measuring module capable of measuring a power value reads a power value (a current value and a voltage value) measured by the power consumption measuring circuit 123 as data indicating an power consumption value, and outputs the read-out data to the CPU 111 (operating system (OS) 113a) via the system controller 115.

The CPU 111 is a processor for controlling the operations of individual components of the personal computer 10. The CPU 111 runs various kinds of software that are loaded into the main memory 113 from the HDD 116, such as the operating system (OS) 113a, various utility programs, and various application programs.

The utility programs include a peak shift utility 113b for implementation of a peak shift function. The peak shift function is a function of performing power management so as to switch the power supply source from the external power device to the battery 17 in a time slot (daytime; e.g., 13:00 to 16:00 in summer) in which the power consumption of the entire society peaks and to charge the battery 17 in a time slot (night) in which the power consumption is small.

The application programs include a power consumption measuring program 113c for processing data indicating power consumption values measured by the power consumption measuring circuit 123. The power consumption measuring program 113c reads, via the OS 113a, data indicating power consumption values that is recorded in a memory 119a (volatile memory) of the EC/KBC 119, and records the read-out data in the HDD 116. The power consumption measuring program 113c performs transmission processing of sending, to an external apparatus (e.g., data server (described later)), data indicating power consumption values that is recorded in the HDD 116, data generation processing of generating data to be sent to the external apparatus, display processing of displaying a picture (e.g., graph) indicating an power variation on the basis of data indicating power consumption values, and other processing. The data generation processing includes data complementing processing for attaining required data accuracy (data amount).

The CPU 111 also runs a BIOS (basic input/output system) which is stored in the BIOS-ROM which is a nonvolatile memory. The BIOS is a system program for hardware control.

The graphics controller 114 is a display controller for controlling the LCD 19 which is used as a display monitor of the personal computer 10.

The system controller 115, which is connected to a PCI bus 1, communicates with devices 130 on the PCI bus 1. A communication device 124, for example, is connected to the PCI bus 1. The communication device 124 controls a communication with an external apparatus (e.g., data server) over a network under the control of the CPU 111. The system controller 115 incorporates a serial ATA controller for controlling the hard disk drive 116 and the optical disc drive 117.

The EC/KBC 119, the power controller (PSC) 120, and the battery 17 are connected to each other via a serial bus 2 such as an I2C bus, and connected to the system controller 115 via an LPC bus. The EC/KBC 119 is a power management controller for performing power management of the personal computer 10, and is implemented as, for example, a one-chip microcomputer incorporating a keyboard controller for controlling the keyboard (KB) 13, the touch pad 15, etc. The EC/KBC 119 has a function of powering on or off the personal computer 10 in response to a user manipulation on the power switch 14, in cooperation with the PSC 120. When receiving an on signal from the EC/KBC 119, the PSC 120 turns on each internal power of the personal computer 10 by controlling the power circuit 121. When receiving an off signal from the EC/KBC 119, the PSC 120 turns off each internal power of the personal computer 10 by controlling the power circuit 121. The EC/KBC 119, the PSC 120, and the power circuit 121 operate on power that is supplied from the battery 17 or the AC adapter 122 even while the personal computer 10 is powered off.

The power circuit 121 generates power (operation power) to be supplied to the individual components using power that is supplied from the battery 17 which is mounted in the computer main body 11 or power that is supplied from the AC adapter 122 which is connected to the computer main body 11 as an external power device. Where the AC adapter 122 is connected to the computer main body 11, the power circuit 121 generation operation power to be supplied to the individual components using power that is supplied from the AC adapter 122 and charges the battery 17 by turning on a charging circuit (not shown). The power circuit 121 includes a detection circuit 121a which outputs signals indicating a voltage value and a current value of the AC adapter 122 and a voltage value and a current value of the battery 17. The PSC 120 generates data indicating the voltage value and the current value of the AC power source and data indicating the voltage value and the current value of the battery 17 on the basis of the signals that are output from the detection circuit 121a.

In the embodiment, the EC/KBC 119, the PSC 120, and the power circuit 121 performs an operation of recording data indicating power consumption values measured by the power consumption measuring circuit 123 not only while the personal computer 10 is powered on but also while it is powered off.

While the personal computer 10 is powered on, the EC/KBC 119 (hereinafter referred to as EC) immediately outputs, to the CPU 111 (OS 113a and power consumption measuring program 113c), via the system controller 115, data indicating power consumption value that is input from the PSC 120 and the power consumption measuring program 113c records the received data in the HDD 116. On the other hand, while the personal computer 10 is powered off, the EC temporarily records, in the memory 119a incorporated therein, data indicating power consumption values that are input from the PSC 120. When the personal computer 10 is powered on next time, the EC outputs the recorded data to the CPU 111 (OS 113a and power consumption measuring program 113c) via the system controller 115 and the power consumption measuring program 113c records the received data in the HDD 116.

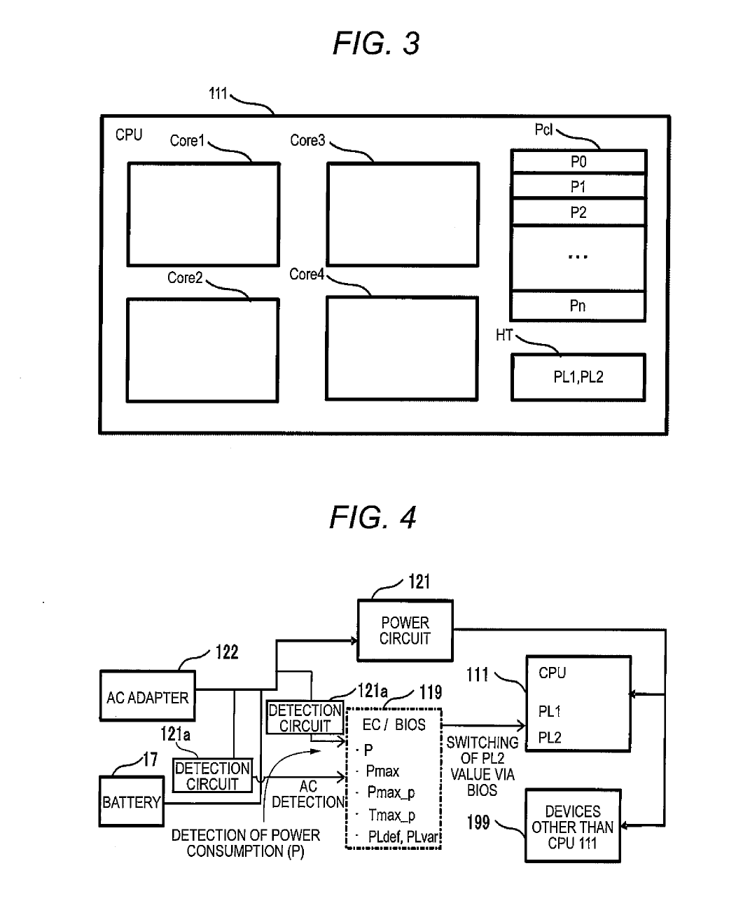

FIG. 3 is a block diagram of the CPU 111 used in the embodiment. The CPU 111 is equipped with four cores (central components for processing), that is, Core1 to Core4. For example, each core is configured so as to exchange data with the outside via a shared (primary) cache (not shown) and a cache memory (not shown) having a role of a secondary cache dedicated to it.

A heat control processing section HT is configured so as to perform a Turbo Boost (registered trademark) frequency limiting control on the basis of PL1 which is a CPU internal setting value indicating a long-term limit value of CPU power consumption and PL2 which is a CPU internal setting value indicating an instantaneous limit value of CPU power consumption.

Frequency values that can be taken by the Turbo Boost frequency are set as an array Pi (0≦i≦n) in a frequency setting array table Pc1 (fixed value registers). The frequency value is largest when the parameter i is equal to 0. As the parameter i increases, the frequency value decreases in units of, for example, a multiple of 100 MHz. A default value of each core is P1. In the embodiment, the Turbo Boost over-TDP (Thermal Design Power) function is supported by the CPU 111.

FIG. 4 is a functional block diagram of the personal computer 10b according to the embodiment. As mentioned above, the power consumption of the entire system of the personal computer 10 is monitored by the EC via the detection circuit 121a. The EC also detects connection/disconnection of the AC adapter 122.

Values registered in internal registers (not shown) of the CPU 111 are parameters that can be set dynamically by the BIOS. The parameter PL1, which is the CPU internal setting value indicating the long-term limit value of CPU power consumption, serves to limit the Turbo Boost frequency so that an average power value of the CPU 111 obtained by averaging over 20 to 30 sec does not exceed PL1. In the embodiment, it is assumed that PL1 is a fixed value. Usually, PL1 is set equal to TDP. The parameter PL2, which is a CPU internal setting value indicating an instantaneous limit value of CPU power consumption, serves to limit the Turbo Boost frequency so that the instantaneous power of the CPU 111 does not exceed PL2.

Parameters as data held (monitored) by the EC will be described below. A parameter P represents a current power consumption of the entire system. A parameter Pmax (for example, a second instantaneous value) represents a maximum rated power value of the AC adapter 122 or the battery 17. A parameter Pmax_p (for example, a first instantaneous value) represents a maximum peak power value of the AC adapter 122 or the battery 17. A parameter Tmax_p represents a maximum time during which the power of the AC adapter 122 or the battery 17 is allowed to exceed the maximum rated power value. The duty ratio is assumed to be 50%. A parameter PLdef (for example, a first value) is a PL2 value that is set so that the instantaneous power of the entire system does not exceed Pmax_p, and is used as an initial value of PL2. A parameter PLvar (for example, a second value) is a PL2 value that is set so that the instantaneous power of the entire system does not exceed Pmax, and satisfies a relationship that PLvar<PLdef.

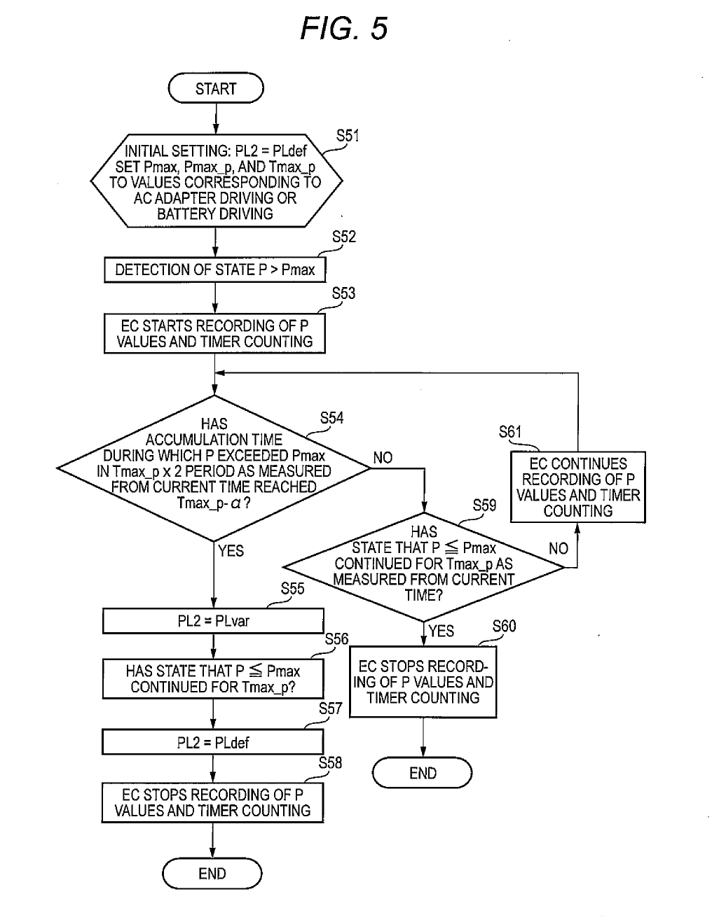

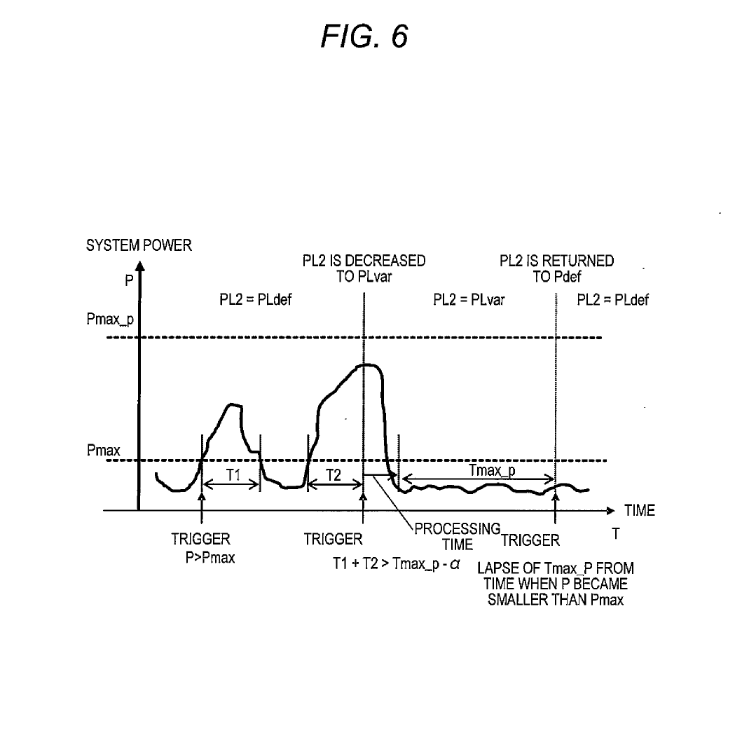

FIG. 5 is a flowchart of the power consumption control. FIG. 6 is a graph showing a system power variation in the embodiment. How the power consumption control is performed (mainly by the EC) will be described below with reference to FIGS. 5 and 6.

Upon booting of the personal computer 10, at step S51, the BIOS sets the initial of PL2 to PLdef. The parameters Pmax, Pmax_p, and Tmax_p are set to values suitable for a specification corresponding to a current status, that is, AC driving or battery driving. When the parameter P which is monitored by the EC exceeds Pmax at step S52, at step S53 timer counting and recording of P values (or values that enable judgment as to whether or not P has exceeded Pmax) are triggered (started). A proper sampling cycle (e.g., 10 ms) is used according to the specification of the EC.

In this embodiment, as described above, the duty ratio is assumed to be 50%. Thus, P is controlled such that an accumulation time during which P exceeds Pmax is not larger than Tmax_p in a period of Tmax_p×2 (for example, a prescribed time period). More specifically, it is judged that the limit defined by the specification has been reached (step S54: yes) when the accumulation time during which P exceeded Pmax in the past Tmax_p×2 period as measured from the current time has reached Tmax_p−α (for example, a first threshold time). At step S55, PL2 is decreased to PLvar so that P becomes smaller than Pmax.

The parameter α is set at a value that is a time taken to actual variation of the CPU power from switching of PL2 by the BIOS plus a proper margin. After P has become smaller than or equal to Pmax, at step S56 waiting is done for Tmax_p (for example, a second threshold time). At step S57, PL2 is returned to PLdef. At step S58, the recording of P values and the timer counting are stopped. Then, the process is finished.

If P has been continuously kept smaller than or equal to Pmax for Tmax_p after the start of the timer counting (triggered by the event that P exceeded Pmax) (step S59: yes), at step S60 the recording of P values and the timer counting are stopped with PL2 kept equal to PLdef. Then, the process is finished. On the other hand, if P has not been continuously kept smaller than or equal to Pmax for Tmax_p (step S59: no), at step S61 the EC continues the recording of P values and the timer counting. Then, the process returns to step S54.

The above embodiment is directed to the case of using an AC adapter and a standard battery. On the other hand, as another embodiment, where an extended batter is supported, since usually an extended battery is larger in capacity (higher in rating) than a standard battery, higher performance can be attained when an extended battery is mounted than when a standard battery is mounted by performing a control with Pmax, Pmax_p, and Tmax_p set to values corresponding to the extended battery. In this case, if the extended battery has run down, it is necessary to return these parameters to values corresponding to the standard battery.

### SUMMARY

For example, in some recent CPU, instantaneous performance is improved by making the power consumption larger than TDP for a short time (20 to 30 sec) utilizing headroom of a temperature increase (over-TDP function). However, this increases the risk that the power consumption of the entire system exceeds the rated power of an AC adapter or a battery (the risk with the battery is higher than with the AC adapter because in general batteries are lower in rating than AC adapters). On the other hand, from the viewpoints of thinning and weight reduction, it is not appropriate to increase the capacities of the AC adapter and the battery indiscreetly.

Conventionally, where it is judged, through calculation (or based on a check by an actual measurement), that the system power consumption may exceed the rated power of an AC adapter or a battery, such an event is prevented by turning off the over-TDP function or limiting related values in advance by controlling CPU interval registers. However, in actuality, an event that the power consumption (peak power) of an AC adapter or a battery exceeds its maximum rated power temporarily is allowable. Therefore, in the above-described control, Turbo Boost is limited with a certain margin.

In the embodiment, Turbo Boost control is optimized to attain highest performance within the confines of the specification items of the maximum rated power and the maximum peak power of the AC adapter or the battery.

For example, a control may be performed by CPU throttling to lower the power consumption. Although this control can lower the power consumption, the standard frequency itself is made lower than the above-mentioned parameter Pn and hence the performance is also lowered. Furthermore, the power consumption may be lowered unduly and the rated power range of a power source cannot be utilized fully.

In the embodiment, the standard frequency itself of the CPU is not changed and the Turbo Boost frequency is restricted by limiting the over-TDP portion of power. Therefore, the performance degradation can be minimized and the rated power range of the power source can be utilized fully.

### SUPPLEMENTS TO EMBODIMENT

(1) The power consumption of the entire system is monitored by the embedded controller (EC). In a Turbo Boost operation of the CPU 111, when the power consumption of the entire system has exceeded the maximum rated power of the AC adapter 122 or the battery 17, the EC triggers (starts) timer counting and recording of power consumption values. Immediately before a time during which the power consumption exceeded the maximum rated power reaches a specification time (about several seconds) of the AC adapter 122 or the battery 17, the over-TDP function is restricted by manipulating the CPU internal registers via the BIOS, whereby the Turbo Boost frequency is limited in the CPU 111. Thus, a control is made so that the power consumption of the entire system is made smaller than the maximum rated power. If the time during which the power consumption exceeded the maximum rated power does not reach the specification time, no limiting is made.

(2) Since the AC adapter 122 and the battery 17 are different from each other (usually, the battery 17 is lower) in the maximum rated power and maximum peak power specifications, connection/disconnection of the AC adapter 122 is detected and the EC triggering condition of the control of the above item (1) is switched so as to be suitable for a specification corresponding to a current status, that is, AC driving or battery driving. Where an extended batter is supported, the triggering condition is switched so as to be suitable for its specification when the extended batter is mounted.

The measures described in items (1) and (2) make it possible to make best use of Turbo Boost within the confines of the specifications of the AC adapter 122, the battery 17, and the extended battery.

The invention is not limited to the above embodiment and may be embodied by variously modifying constituent elements without departing from the spirit and scope of the invention. And various inventive concepts may be conceived by properly combining plural constituent elements disclosed in the embodiments. For example, several ones of the constituent elements of the embodiment may be omitted.

1. An information processing apparatus comprising:
a main body;
a CPU in the main body, comprising a limit value configured to limit an instantaneous power consumption of the CPU;
a measuring module configured to measure a power supplied to the main body; and
a setting module configured to set a first value as the limit value so that the power does not exceed a first instantaneous value,
wherein, when the duration of time during which the power exceeds a second instantaneous value reaches a first threshold time within a first time period, the setting module further sets a second value as the limit value so that the power does not exceed the second instantaneous value, where in the second instantaneous value is smaller than the first instantaneous value.

2. The information processing apparatus of claim 1,
wherein, when a continuous time of the power lower than or equal to the second instantaneous value reaches a second threshold time, the setting module resets the first value as the limit value.

3. The information processing apparatus of claim 1,
wherein the first instantaneous value and/or the second instantaneous value vary depending on a type and/or a rated power of a power source configured to supply the power to the main body.

4. A control method for an information processing apparatus comprising a main body and a CPU comprising a limit value configured to limit an instantaneous power consumption of the CPU, the method comprising:
measuring a power supplied to the main body;
setting a first value as the limit value so that the power does not exceed a first instantaneous value; and
further setting, when duration of time during which the power exceeds a second instantaneous value reaches a first threshold time within a first time period, a second value as the limit value so that the power does not exceed the second instantaneous value, wherein the second instantaneous value is small than the first instantaneous values.
